(19) United States
(12) Patent Application Publication
(10) Pub. No.: US 2003/0211357 A1
(43) Pub. Date: Nov. 13, 2003

(54) Copper alloy material having efficient press properties and process for production thereof

(75) Inventors: Koji Harada, Koza-gun (JP); Kazuhiko Fukamachi, Koza-gun (JP)

Correspondence Address: OLIFF & BERRIDGE, PLC, P.O. BOX 19928, ALEXANDRIA, VA, 22320, US

(73) Assignee: NIPPON MINING & METALS CO., LTD., Minato-ku (JP)

(21) Appl. No.: 10/397,200

(22) Filed: Mar. 27, 2003

(30) Foreign Application Priority Data
Mar. 29, 2002 (JP) 2002-097607

(51) Int. Cl. B32B 15/04

(52) U.S. Cl. 428/687; 428/469

(57) ABSTRACT

A copper alloy material for connectors for reducing wear of a press die, the material comprising: 25 to 40 mass % of Zn and the balance of Cu and inevitable impurities; the material having an arithmetic mean surface roughness (Ra) along a direction perpendicular to a rolling direction for the material of 0.07 to 0.13 μm; maximum height (Ry) of not more than 1.3 μm; a surface oxide film having a thickness in a range of from 3 to 80 nm; and not less than 10 atom % of oxide of alloy elements, except for Cu, contained in the oxide film.

### BACKGROUND OF THE INVENTION

1. Technical Field

The present invention relates to a copper alloy material causing low amounts of wear on a press die and to a process for production of the copper alloy material, and in particular, relates to a copper alloy material and to a process for production thereof which can reduce the amount of wear on a press die and can improve life of the die by having surface roughness which can efficiently hold a lubricating oil, during press working in production processes for electronic parts such as terminals, connectors, and the like.

2. Background Art

Generally, copper alloys are used in electronic parts such as terminals, connectors, and the like from the viewpoints of mechanical strength and conductivity, and furthermore, in view of soldering properties and plating properties. Recently, use of precipitation hardening type copper alloy is increasing instead of use of solid solution hardening copper alloys represented by phosphor bronze, brass, or the like, and there is a tendency for the material to have higher strength.

However, damage to a die during press working increases when high strength materials are used. Furthermore, low viscosity lubricating oils which are easily degreased tend to be used, whereby damage to dies is further increased, therefore, it is desired to extend the life of such dies.

### SUMMARY OF THE INVENTION

An object of the present invention is to provide a copper alloy for electronic materials which can be used as high-strength materials and to provide low viscosity lubricating oils and which cause low amounts of wear of dies.

The inventors researched to deal with the problems mentioned above and found a way to reduce wear amounts of a die by controlling an mean surface roughness on a surface of a material along a direction perpendicular to a rolling direction, thickness and composition of a surface oxide film, and surface tension of the material.

The present invention provides a copper alloy material for connectors causing less wear of a press die, the material comprising: 25 to 40 mass % of Zn, and the balance of Cu and inevitable impurities; the arithmetic mean surface roughness (Ra) along a direction perpendicular to a rolling direction for the material is in a range of from 0.07 to 0.13 μm and the maximum height (Ry) is not more than 1.3 μm; a surface oxide film has a thickness in a range of from 3 to 80 nm; and not less than 10 atom % of oxide of alloy elements, except for Cu, is contained in the oxide film.

The present invention provides a copper alloy material for connectors causing less wear of a press die, the material comprising: 3 to 11 mass % of Sn; 0.03 to 0.35 mass % of P; and the balance of Cu and inevitable impurities; the arithmetic mean surface roughness (Ra) along a direction perpendicular to a rolling direction for the material is in a range of from 0.07 to 0.14 μm and the maximum height (Ry) is not more than 1.4 μm; a surface oxide film has a thickness in a range of from 3 to 80 nm; and not less than 10 atom % of oxide of alloy elements, except for Cu, is contained in the oxide film.

The present invention provides a copper alloy material for connectors causing less wear of a press die, the material comprising: 1.5 to 4.0 mass % of Ni; 0.30 to 1.2 mass % of Si; and the balance of Cu and inevitable impurities; the arithmetic mean surface roughness (Ra) along a direction perpendicular to a rolling direction for the material is in a range of from 0.05 to 0.15 μm and the maximum height (Ry) is not more than 1.5μm; a surface oxide film has a thickness of in a range of from 3 to 80 nm; and not less than 10 atom % of oxide of alloy elements, except for Cu, is contained in the oxide film.

The present invention provides a copper alloy material for connectors causing less wear of a press die, the material comprising: 1.5 to 4.0 mass % of Ni; 0.30 to 1.2 mass % of Si; 0.05 to 0.20 mass % of Mg; and the balance of Cu and inevitable impurities; the arithmetic mean surface roughness (Ra) along a direction perpendicular to a rolling direction for the material is in a range of from 0.05 to 0.15 μm and the maximum height (Ry) is not more than 1.5 μm; a surface oxide film has a thickness of in a range of from 3 to 80 nm; and not less than 10 atom % of oxide of alloy elements, except for Cu, is contained in the oxide film.

The present invention provides a copper alloy material for connectors causing less wear of a press die, the material comprising: 0.5 to 5 mass % of Ti, and the balance of Cu and inevitable impurities; the arithmetic mean surface roughness (Ra) along a direction perpendicular to a rolling direction for the material is in a range of from 0.10 to 0.18 μm and the maximum height (Ry) is not more than 2.0 μm; a surface oxide film has a thickness in a range of from 3 to 80 nm; and not less than 10 atom % of oxide of alloy elements, except for Cu, contained in the oxide film.

Furthermore, in the copper alloy of the present invention, Ag, Al, Co, Cr, Fe, In, Mg, Mn, Ni, P, Si, Sn, Ti, Zn, Zr or the like can be added at 0.001 to 1.5 mass % in total amount to improve the strength.

The copper alloy material may have a wet tension (surface tension) with oil of more than 30 mN/m.

The present invention provides a process for production of the above mentioned copper alloy material for connectors having low wear amount of the press die, wherein the moderate surface roughness, and lubricant oil is hard to be removed from the surface which is obtained by mechanical surface treatment.

The mechanical surface treatment may be surface grinding.

The mechanical surface grinding may be performed immediately before press working.

The mechanical surface treatment may be performed by rolling.

“Arithmetic mean roughness (Ra)” refers to a value in μm which can be obtained by following formula (1) in the case in which a reference piece is sampled with a specific length in a roughness curve along the direction of its mean line, the X axis is defined along the direction of the average line of the sampled piece, the Y axis is defined along the direction of longitudinal magnification, and the roughness curve is expressed by Y=f(x).

$${R}_{a} = \frac{1}{1} {\int }_{0}^{1} \vert f ( x ) \vert ⅆ x$$

(1: length of reference piece) (formula 1)

Furthermore, “maximum height (Ry)” refers to a value in μm in the case in which a reference piece is sampled with a specific length in a roughness curve along the direction of its mean line, and the distance between the top line and the bottom line of the selected piece is measured along the direction of longitudinal magnification of the roughness curve.

Reasons for the limitation of Ra and Ry will be explained hereinafter.

(1) Surface Roughness

If the existence of a lubricating oil coating is insufficient in press working a material, wear of the die may progress. This phenomenon can be reduced by forming rough portions on the surface of material to some extent. The dents hold lubricating oil and the lubricating oil may be hard to be removed from the surface. Therefore, a parameter for roughness must be defined specifically by Ra and Ry. The reason for limitation of the Ra of the material for electronic parts of the present invention is that the effect of reducing the wear amount of the die cannot be obtained if Ra is below the range and the effect of reducing the wear amount of die may plateau if Ra is above this range. Furthermore, in the latter case, metallic powder is produced in a rolling process or a grinding process in which rough portions of the material are formed, and the metallic powder adheres to the surface of material, causing wear of the die. The reason for limitation of Ry is that bending cracks initiated from a rough portion of the material may occur in press bending processes if Ry is above this range.

Furthermore, the reasons for limitation of Ra and Ry for each kind of alloy are that the effect of reducing wear amount of die can be further obtained by increasing roughness proportionally as the strength of material is increased, and that precipitation hardening type alloy (Corson, titanium copper based) can obtain similar effects by making the surface rougher compared to the case of the solid solution hardening type alloy (brass, phosphor bronze based). Therefore, a material having a composition according to a first aspect of the invention the arithmetic mean roughness (Ra) is limited to a range of 0.07 to 0.13 μm and the maximum height (Ry) is not more than 1.3 μm, a material has composition according to a second aspect of the invention the Ra is limited to a range of 0.07 to 0.14 μm and the Ry is not more than 1.4 μm, a material having composition according to a third aspect of the invention the Ra is limited to a range of 0.05 to 0.15 μm and the Ry is not more than 1.5 μm, and a material having composition according to a fourth aspect of the invention the Ra is limited to a range of 0.10 to 0.18 μm and the Ry is not more than 2.0 μm.

The surface roughness described above can be obtained by mechanical surface treatment, for example, can be obtained by controlling surface roughness of a roll of mill in a rolling process and can be obtained by mechanically grinding the surface after rolling.

(2) Thickness of Oxide Film and Compositions of Oxide Film

If the thickness of the oxide film of the surface of the material is less than 3 nm, adhesion wear of die with the material in press working may increase, and if the thickness of the oxide film of the surface of the material is greater than 80 nm, wettability of lubricating oil is deteriorated and wear of die may increase. If the content of oxidized alloy element, except for Cu, in the oxide film is less than 10 atom %, concentration of CuO increases, whereby wettability of the lubricating oil is deteriorated and wear of die may increase. The thickness and composition of the oxide film on the surface of material can be controlled by controlling the annealing atmosphere at the annealing processing. Furthermore, if a pickling process is used, the thickness of the oxide film can also be controlled by the conditions (conditions of acid pickling, conditions of water washing and drying).

(3) Wet Tension

Wettability of the lubricating oil is deteriorated and wear of die may increase if the wet tension is less than 30 mN/m. The wet tension can be obtained by controlling surface roughness, thickness and composition of the oxide film. Therefore, it is necessary to control each condition of rolling process, annealing process, and pickling process.

### EXAMPLES

The present invention is explained in detail by way of examples and comparative examples. First, specific amounts of electrolytic copper or oxygen-free copper as a raw material and other added elements, if necessary, were charged into a vacuum melting furnace and were melted at 1250° C. to obtain ingots having compositions shown in Table 1.

TABLE 1

| Alloy | | | | | | | | Cu and |
|---|---|---|---|---|---|---|---|---|
| No. | Zn | Sn | P | Ni | Si | Mg | Ti | impurity |
| 1 | 30.27 | — | — | — | — | — | — | Balance |
| 2 | 34.88 | — | — | — | — | — | — | Balance |
| 3 | — | 4 | 0.04 | — | — | — | — | Balance |
| 4 | — | 7.98 | 0.02 | — | — | — | — | Balance |
| 5 | — | — | — | 1.73 | 0.44 | 0.09 | — | Balance |
| 6 | — | — | — | 2.6 | 0.71 | 0.19 | — | Balance |
| 7 | — | — | — | — | — | — | 2.9 | Balance |
| 8 | — | — | — | — | — | — | 3.15 | Balance |

Next, hot rolling process at 950° C. was performed on these ingots to obtain plates having a thickness of 10 mm. Cold rolling was performed on phosphor bronze ingots to obtain plate having thickness of 10 mm. Then, the oxide layer on the surface was removed by mechanical grinding, and cold rolling process was performed to obtain plates having a thickness of 5 mm. Subsequently, first recrystallization annealing was performed in the case of solid solution hardening type copper alloy, and a solution treatment was performed in the case of precipitation hardening type of the copper alloy. Furthermore, cold rolling was performed to obtain sheets having a thickness of 1.5 mm and second recrystallization annealing was performed in the case of the solid solution hardening type copper alloy sheet and solution treatment was performed in the case of the precipitation hardening type copper alloy sheet. By controlling the annealing atmosphere, sheets having different kinds of oxide films were produced. Then, sheets having a thickness of 0.15 mm were produced by final cold rolling. In the case of the solid solution hardening type copper alloy sheet, following mechanical surface grinding was performed by a buff containing an abrasive and SiC having various roughnesses. In the case of the precipitation hardening type copper alloy sheet, after performing aging treatment under a non-oxidizing atmosphere such as Ar in temperature conditions so as to obtain the highest strength, mechanical surface grinding was performed by a buff containing abrasive and SiC having various roughnesses. In addition, after the second recrystallization annealing or the solution treatment was performed in almost the same conditions, other sheets on which rolling processes were performed by rolls having various surface roughnesses in the final rolling process were also produced. It should be noted that these rolls having various surface roughnesses were prepared by varying the particle sizes of grindstones in grinding processes of rolls. Then, in the case of the precipitation hardening type copper alloy sheet, aging treatment under a non-oxidizing atmosphere such as Ar was performed. The materials prepared as described above having various surface roughnesses were evaluated.

The oxide films were measured by a GDS (glow discharge emission spectrophotometer), wherein the thickness of the oxide film was defined by a depth from the surface to a portion where the oxygen concentration decreased to less than 2% of that in the surface according to a profile of the oxygen concentration in the depth direction.

Furthermore, composition of the oxide film was measured by a GDS, wherein a portion having the highest oxygen concentration was specified according to the profile of the oxygen concentration, and ratio of sum of concentrations of alloy elements, except for Cu, with respect to the sum of concentrations of alloy elements.

The wet tension was measured according to “Plastic-film and sheet-testing method for wet tension” in Japanese Industrial Standard (JIS) K 6768: 1999.

Next, a punching based die wear test was performed on these obtained kinds of copper alloy sheets. A commercial die made of WC base cemented carbide which includes 0.16% of Co and the balance of WC was used. 700,000 circular pieces having a diameter of 3 mm were punched, the average diameter of 20 punched holes which were punched first, and the average diameter of 20 punched holes which were punched last, were measured. The difference in these average values was defined as wear amount of the die. A wear amount of the Example of the present invention which has a similar composition to a conventional copper alloy material was defined as 1, and wear amounts of copper alloys of Comparative Examples were expressed by a relative value to the defined value of the Example to evaluate reducing effects of wear amount against punching of copper alloy sheets.

### Example 1

Examples according to the first aspect of the invention and Comparative Examples are shown in Table 2. In Table 2, oxygen concentration in the annealing process, particle size of the buff in the mechanical grinding process, and particle size of grinding particles in the roll grinding process are also added. No. 1 and 5 exhibit superior wet tension and wear amount reducing effect. There was no difference in wear amount between No. 1 in which surface roughness was controlled by mechanical grinding and No. 5 in which surface roughness was controlled by surface roughness of the roll. The wear amount of No. 1 is defined as 1, and the wear amount of No. 2 to 4 are expressed by a relative value to the defined value of No. 1. The wear amount of No. 5 is also defined as 1, and the wear amount of No. 6 to 8 are expressed by a relative value to the defined value of No. 5. Because the oxide film of No. 2 is more than 80 nm and the oxide film of No. 3 is less than 3 nm, the wear amount of the die was increased in each case. Furthermore, concentration of the oxide film, except for CuO, is not more than 10% in No. 4, and the wear amount of the die increased. Because Ra of No. 6 is less than 0.07 μm and Ra of No. 7 is more than 0.13 μm, the wear amount of the die was also increased. Because Ry of No. 8 is more than 1.3 μm, the wear amount of die is increased.

TABLE 2

| | | | | | | | | | | | Wear | |
|---|---|---|---|---|---|---|---|---|---|---|---|---|
| | | Production | | | | | | | | | amount | |
| | | method of | Annealing | Mechanical | Roll | Thickness | Composition | Wet | Surface | | of die | |
| | Alloy | surface | atmosphere | grinding | (particle | of oxide | of oxide film¹⁾ | tension | roughness (μm) | | (relative | |
| No. | No. | roughness | (O₂ %) | (particle size) | size) | film (nm) | (atom %) | (mN/m) | Ra | Ry | ratio)²⁾ | Remarks |
| 1 | 1 | Mechanical | 0.02 | #3000 | | 21 | 15.2 | 34 | 0.12 | 1.2 | 1.00 | Example |
| | | grinding | | | | | | | | | | |
| 2 | 1 | Mechanical | 0.09 | #3000 | | 100 | 10.5 | 26 | 0.11 | 1.0 | 1.85 | Comparative |
| | | grinding | | | | | | | | | | example |
| 3 | 1 | Mechanical | 0.01 | #2400 | | 2 | 11.0 | 31 | 0.08 | 1.3 | 1.58 | |
| | | grinding | | | | | | | | | | |
| 4 | 1 | Mechanical | 0.05 | #3000 | | 72 | 8.3 | 26 | 0.09 | 1.1 | 1.48 | |
| | | grinding | | | | | | | | | | |
| 5 | 2 | Rolling | 0.03 | | #400 | 33 | 10.3 | 36 | 0.10 | 1.1 | 1.00 | Example |
| 6 | 2 | Rolling | 0.03 | | #500 | 62 | 12.4 | 36 | 0.05 | 0.8 | 1.82 | Comparative |
| 7 | 2 | Rolling | 0.03 | | #240 | 54 | 13.2 | 28 | 0.15 | 1.2 | 1.66 | example |
| 8 | 2 | Rolling | 0.03 | | #320 | 60 | 11.5 | 31 | 0.11 | 1.4 | 1.42 | |

| | | | | | |
|---|---|---|---|---|---|
| Characteristic range | 3 to 80 | Not less | Not less | 0.07 | Not more |
| | | than 10 | than 30 | to | than 1.3 |
| | | | | 0.13 | |

¹⁾Compositions of oxide film except for CuO
²⁾Relative ratio against wear amount of Example

### Example 2

Examples according to the second aspect of the invention and Comparative Examples are shown in Table 3. No. 9 and 13 are the Examples of the present invention, and No. 10 (the case in which the thickness of the oxide film is more than 80 nm), No. 11 (the case in which the thickness of the oxide film is less than 3 nm), No. 12 (the case in which the concentration in the oxide film, except for CuO, is less than 10 atom %), No. 14 (the case in which Ra is less than 0.07 μm), No. 15 (the case in which Ra is more than 0.14 μm), and No. 16 (the case in which Ry is more than 1.4 μm) are Comparative Examples.

TABLE 3

| | | | | | | | | | | | Wear | |
|---|---|---|---|---|---|---|---|---|---|---|---|---|
| | | Production | | | | | | | | | amount | |
| | | method of | Annealing | Mechanical | Roll | Thickness | Composition | Wet | Surface | | of die | |
| | Alloy | surface | atmosphere | grinding | (particle | of oxide | of oxide film¹⁾ | tension | roughness (μm) | | (relative | |
| No. | No. | roughness | (O₂ %) | (particle size) | size) | film (nm) | (atom %) | (mN/m) | Ra | Ry | ratio)²⁾ | Remarks |
| 9 | 3 | Mechanical | 0.02 | #3000 | | 56 | 10.7 | 36 | 0.11 | 1.0 | 1.00 | Example |
| | | grinding | | | | | | | | | | |
| 10 | 3 | Mechanical | 0.07 | #4000 | | 87 | 10.9 | 28 | 0.08 | 1.1 | 1.57 | Comparative |
| | | grinding | | | | | | | | | | example |
| 11 | 3 | Mechanical | 0.01 | #3000 | | 2 | 12.6 | 30 | 0.09 | 1.1 | 1.50 | |
| | | grinding | | | | | | | | | | |
| 12 | 3 | Mechanical | 0.04 | #4000 | | 57 | 8.3 | 31 | 0.07 | 1.0 | 1.46 | |
| | | grinding | | | | | | | | | | |
| 13 | 4 | Rolling | 0.02 | | #400 | 18 | 12.6 | 32 | 0.09 | 1.0 | 1.00 | Example |
| 14 | 4 | Rolling | 0.02 | | #500 | 28 | 10.5 | 36 | 0.06 | 0.9 | 1.54 | Comparative |
| 15 | 4 | Rolling | 0.03 | | #320 | 45 | 11.6 | 27 | 0.15 | 0.7 | 1.60 | example |
| 16 | 4 | Rolling | 0.03 | | #400 | 30 | 10.8 | 32 | 0.09 | 1.6 | 1.45 | |

| | | | | | |
|---|---|---|---|---|---|
| Characteristic range | 3 to 80 | Not less | Not less | 0.07 | Not more |
| | | than 10 | than 30 | to | than 1.4 |
| | | | | 0.14 | |

¹⁾Compositions of oxide film except for CuO
²⁾Relative ratio against wear amount of Example

### Example 3

Examples according to the third aspect of the invention and Comparative Examples are shown in Table 4. No. 17 and 21 are the Examples of the present invention, and No. 18 (the case in which the thickness of the oxide film is more than 80 nm), No. 19 (the case in which the thickness of the oxide film is less than 3 nm), No. 20 (the case in which the concentration in the oxide film, except for CuO, is less than 10 atom %), No. 22 (the case in which Ra is less than 0.05 μm), No. 23 (the case in which Ra is more than 0.15 μm), and No. 24 (the case in which Ry is more than 1.5 μm) are Comparative Examples.

TABLE 4

| | | | | | | | | | | | Wear | |
|---|---|---|---|---|---|---|---|---|---|---|---|---|
| | | Production | | | | | | | | | amount | |
| | | method of | Annealing | Mechanical | Roll | Thickness | Composition | Wet | Surface | | of die | |
| | Alloy | surface | atmosphere | grinding | (particle | of oxide | of oxide film¹⁾ | tension | roughness (μm) | | (relative | |
| No. | No. | roughness | (O₂ %) | (particle size) | size) | film (nm) | (atom %) | (mN/m) | Ra | Ry | ratio)²⁾ | Remarks |
| 17 | 5 | Mechanical | 0.01 | #3000 | | 12 | 11.1 | 38 | 0.09 | 1.0 | 1.00 | Example |
| | | grinding | | | | | | | | | | |
| 18 | 5 | Mechanical | 0.08 | #4000 | | 95 | 10.3 | 26 | 0.04 | 1.0 | 1.98 | Comparative |
| | | grinding | | | | | | | | | | example |
| 19 | 5 | Mechanical | 0.01 | #4000 | | 2 | 11.3 | 29 | 0.05 | 1.1 | 1.57 | |
| | | grinding | | | | | | | | | | |
| 20 | 5 | Mechanical | 0.02 | #3000 | | 23 | 7.2 | 32 | 0.08 | 1.2 | 1.68 | |
| | | grinding | | | | | | | | | | |
| 21 | 6 | Rolling | 0.02 | | #400 | 51 | 10.2 | 34 | 0.12 | 1.3 | 1.00 | Example |
| 22 | 6 | Rolling | 0.02 | | #500 | 56 | 9.9 | 36 | 0.04 | 0.9 | 1.67 | Comparative |
| 23 | 6 | Rolling | 0.02 | | #320 | 54 | 11.2 | 27 | 0.17 | 1.3 | 1.84 | example |
| 24 | 6 | Rolling | 0.02 | | #240 | 40 | 12.2 | 30 | 0.13 | 1.7 | 1.45 | |

| | | | | | |
|---|---|---|---|---|---|
| Characteristic range | 3 to 80 | Not less | Not less | 0.07 | Not more |
| | | than 10 | than 30 | to | than 1.5 |
| | | | | 0.15 | |

¹⁾Compositions of oxide film except for CuO
²⁾Relative ratio against wear amount of Example

### Examples 4

Examples of alloys according to the fourth aspect of the invention and Comparative Examples are shown in Table 5. No. 25 and 29 are the Examples of the present invention, and No. 26 (the case in which the thickness of the oxide film is more than 80 nm), No. 27 (the case in which the thickness of the oxide film is less than 3 nm), No. 28 (the case in which the concentration of the oxide film, except for CuO, is less than 10 atom %), No. 30 (the case in which Ra is less than 0.10 μm), No. 31 (the case in which Ra is more than 0.18 μm), and No. 32 (the case in which Ry is more than 2.0 μm) are Comparative Examples.

TABLE 5

| | | | | | | | | | | | Wear | |
|---|---|---|---|---|---|---|---|---|---|---|---|---|
| | | Production | | | | | | | | | amount | |
| | | method of | Annealing | Mechanical | Roll | Thickness | Composition | Wet | Surface | | of die | |
| | Alloy | surface | atmosphere | grinding | (particle | of oxide | of oxide film¹⁾ | tension | roughness (μm) | | (relative | |
| No. | No. | roughness | (O₂ %) | (particle size) | size) | film (nm) | (atom %) | (mN/m) | Ra | Ry | ratio)²⁾ | Remarks |
| 25 | 7 | Mechanical | 0.02 | #3000 | | 23 | 10.8 | 34 | 0.15 | 1.8 | 1.00 | Example |
| | | grinding | | | | | | | | | | |
| 26 | 7 | Mechanical | 0.07 | #4000 | | 84 | 10.4 | 28 | 0.10 | 1.2 | 1.72 | Comparative |
| | | grinding | | | | | | | | | | example |
| 27 | 7 | Mechanical | 0.01 | #4000 | | 2 | 10.2 | 29 | 0.10 | 1.5 | 1.44 | |
| | | grinding | | | | | | | | | | |
| 28 | 7 | Mechanical | 0.04 | #3000 | | 72 | 6.4 | 27 | 0.15 | 1.5 | 1.54 | |
| | | grinding | | | | | | | | | | |
| 29 | 8 | Rolling | 0.02 | | #400 | 66 | 10.1 | 36 | 0.14 | 2.0 | 1.00 | Example |
| 30 | 8 | Rolling | 0.02 | | #500 | 69 | 12.0 | 38 | 0.08 | 1.0 | 1.54 | Comparative |
| 31 | 8 | Rolling | 0.02 | | #240 | 45 | 10.8 | 32 | 0.22 | 1.5 | 1.54 | example |
| 32 | 8 | Rolling | 0.02 | | #400 | 55 | 11.2 | 36 | 0.09 | 2.3 | 1.36 | |

| | | | | | |
|---|---|---|---|---|---|
| Characteristic range | 3 to 80 | Not less | Not less | 0.10 | Not more |
| | | than 10 | than 30 | to | than 2.0 |
| | | | | 0.18 | |

¹⁾Compositions of oxide film except for CuO
²⁾Relative ratio against wear amount of Example

As explained thus far, the copper alloy material of the present invention can sufficiently reduce the amount of wear of dies. Therefore, in working processes for electronic parts or the like, the copper alloy material of the present invention can be applied even in the case in which material having high strength or lubricating oil having low viscosity is used.

What is claimed is:

1. A copper alloy material comprising:
25 to 40 mass % of Zn; and
the balance of Cu and inevitable impurities;
wherein arithmetic mean surface roughness (Ra) along a direction perpendicular to a rolling direction for the material is 0.07 to 0.13 μm;
maximum height (Ry) is not more than 1.3 μm;
a surface oxide film has a thickness in a range of from 3 to 80 nm; and
not less than 10 atom % of oxide of alloy elements, except for Cu, is contained in the oxide film.

2. A copper alloy material comprising:
3 to 11 mass % of Sn;
0.03 to 0.35 mass % of P; and
the balance of Cu and inevitable impurities;
wherein arithmetic mean surface roughness (Ra) along a direction perpendicular to a rolling direction for the material is 0.07 to 0.14 μm;
maximum height (Ry) is not more than 1.4 μm;
a surface oxide film has a thickness in a range of from 3 to 80 nm; and
not less than 10 atom % of oxide of alloy elements, except for Cu, is contained in the oxide film.

3. A copper alloy material comprising:
1.5 to 4.0 mass % of Ni;
0.30 to 1.2 mass % of Si; and
the balance of Cu and inevitable impurities;
wherein arithmetic mean surface roughness (Ra) along a direction perpendicular to a rolling direction for the material is 0.05 to 0.15 μm;
maximum height (Ry) is not more than 1.5 μm;
a surface oxide film has a thickness in a range of from 3 to 80 nm; and
not less than 10 atom % of oxide of alloy elements, except for Cu, is contained in the oxide film.

4. A copper alloy material comprising:
1.5 to 4.0 mass % of Ni;
0.30 to 1.2 mass % of Si;
0.05 to 0.20 mass % of Mg; and
the balance of Cu and inevitable impurities;
wherein arithmetic mean surface roughness (Ra) along a direction perpendicular to a rolling direction for the material is 0.05 to 0.15 μm;
maximum height (Ry) is not more than 1.5 μm;
a surface oxide film has a thickness in a range of from 3 to 80 nm; and
not less than 10 atom % of oxide of alloy elements, except for Cu, is contained in the oxide film.

5. A copper alloy material comprising:
0.5 to 5 mass % of Ti; and
the balance of Cu and inevitable impurities;
wherein arithmetic mean surface roughness (Ra) along a direction perpendicular to a rolling direction for the material is 0.10 to 0.18 μm;
maximum height (Ry) is not more than 2.0 μm;
a surface oxide film has a thickness in a range of from 3 to 80 nm; and
not less than 10 atom % of oxide of alloy elements, except for Cu, is contained in the oxide film.

6. The copper alloy material according to claim 1, wherein the material has a wet tension (surface tension) of more than 30 mN/m with an oil.

7. The copper alloy material according to claim 2, wherein the material has a wet tension (surface tension) of more than 30 mN/m with an oil.

8. The copper alloy material according to claim 3, wherein the material has a wet tension (surface tension) of more than 30 mN/m with an oil.

9. The copper alloy material according to claim 4, wherein the material has a wet tension (surface tension) of more than 30 mN/m with an oil.

10. The copper alloy material according to claim 5, wherein the material has a wet tension (surface tension) of more than 30 mN/m with an oil.

11. A process for production of the copper alloy material according to claim 1, wherein the surface roughness is obtained by a mechanical surface treatment.

12. A process for production of the copper alloy material according to claim 2, wherein the surface roughness is obtained by a mechanical surface treatment.

13. A process for production of the copper alloy material according to claim 3, wherein the surface roughness is obtained by a mechanical surface treatment.

14. A process for production of the copper alloy material according to claim 4, wherein the surface roughness is obtained by a mechanical surface treatment.

15. A process for production of the copper alloy material according to claim 5, wherein the surface roughness is obtained by a mechanical surface treatment.

16. The process for production of the copper alloy material according to claim 11, wherein the mechanical surface treatment is performed by surface grinding.

17. The process for production of the copper alloy material according to claim 12, wherein the mechanical surface treatment is performed by surface grinding.

18. The process for production of the copper alloy material according to claim 13, wherein the mechanical surface treatment is performed by surface grinding.

19. The process for production of the copper alloy material according to claim 14, wherein the mechanical surface treatment is performed by surface grinding.

20. The process for production of the copper alloy material according to claim 15, wherein the mechanical surface treatment is performed by surface grinding.

21. The process for production of the copper alloy material according to claim 16, wherein the mechanical surface grinding is performed just before press working.

22. The process for production of the copper alloy material according to claim 17, wherein the mechanical surface grinding is performed just before press working.

23. The process for production of the copper alloy material according to claim 18, wherein the mechanical surface grinding is performed just before press working.

24. The process for production of the copper alloy material according to claim 19, wherein the mechanical surface grinding is performed just before press working.

25. The process for production of the copper alloy material according to claim 20, wherein the mechanical surface grinding is performed just before press working.

26. The process for production of the copper alloy material according to claim 11, wherein the mechanical surface treatment is performed by rolling.

27. The process for production of the copper alloy material according to claim 12, wherein the mechanical surface treatment is performed by rolling.

28. The process for production of the copper alloy material according to claim 13, wherein the mechanical surface treatment is performed by rolling.

29. The process for production of the copper alloy material according to claim 14, wherein the mechanical surface treatment is performed by rolling.

30. The process for production of the copper alloy material according to claim 15, wherein the mechanical surface treatment is performed by rolling.
